(19) United States
(12) Patent Application Publication
(10) Pub. No.: US 2009/0097023 A1
(43) Pub. Date: Apr. 16, 2009

(54) MOLECULAR DYE FOR SPECTROSCOPY

(75) Inventor: Richard Gilbert, Essex (GB)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: E2V Biosensors Limited, Chelmsford, Essex (GB)

(21) Appl. No.: 12/279,909

(22) PCT Filed: Feb. 20, 2007
(86) PCT No.: PCT/GB07/00578

§ 371 Date: Dec. 23, 2008

(30) Foreign Application Priority Data
Feb. 20, 2006 (GB) 0603355.9
Oct. 16, 2006 (GB) 0620493.7

(51) Int. Cl. G01J 3/44; C07F 15/02

(52) U.S. Cl. 356/301; 546/10

(57) ABSTRACT

A method of detecting the presence, absence or quantity of a dye in a sample in a reaction region is provided, comprising the steps of providing a dye comprising a ligand ion complex, the ligand having a lowest unoccupied electron level and the ion having an excited electron level, the lowest unoccupied electron level of the ligand having an energy level such that an electron in the excited electron level of the ion may transfer non radiatively to the lowest unoccupied electron level of the ligand, the complex having a ground state electron level; illuminating the dye with a specified wavelength of radiation to detect the presence, absence or quantity of dye; detecting radiation from the illuminated dye; wherein the electron levels of the complex and the wavelength of the radiation are arranged such that electrons in the ground state are promoted to an excited state by photon absorption and it is energetically favourable for electrons to transfer to the lowest unoccupied electron level of the ligand from the excited electron level of the ion and undergo non-radiative relaxation via a thermally accessible electron level between the ground state electron level of the complex and the excited electron level of the ion to the ground state electron level.

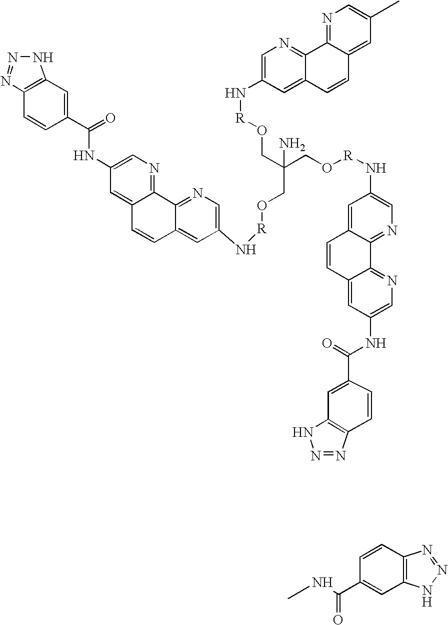

### FIELD OF THE INVENTION

The present invention relates to a molecular dye for use in spectroscopy. The invention particularly relates to dyes used in spectroscopic techniques which use light scattering, such as Raman scattering.

### BACKGROUND OF THE INVENTION

It is known that there are many techniques to detect the action or presence of analyte molecules. One such technique utilises the Raman Scattering (RS) effect. When light is scattered from a molecule, most of the photons are elastically scattered. The majority of the scattered photons have the same energy (and therefore frequency and wavelength) as the incident photons. However, a small fraction of the light (approximately 1 in 10⁷ photons) is scattered at frequencies different from that of the incident photons. When the scattered photon loses energy to the molecule, it has a longer wavelength than the incident photon (termed Stokes scatter). Conversely, when a scattered photon gains energy, it has a shorter wavelength (termed anti-Stokes scatter). Stokes scatter is usually the stronger effect.

The process leading to this inelastic scatter is termed the Raman effect after Sir C. V. Raman, who first described it in 1928. It is associated with a change in the vibrational, rotational or electronic energy of the molecule, with the energy transferred from the photon to the molecule usually being dissipated as heat. The energy difference between the incident photon and the Raman scattered photon is equal to the energy of a vibrational state or electronic transition of the scattering molecule, giving rise to scattered photons at quantised energy differences from the incident laser. A plot of the intensity of the scattered light versus the energy or wavelength difference is termed the Raman spectrum, and the technique is known as Raman spectroscopy (RS).

Surface enhanced Raman spectroscopy (SERS) is a variant of the RS analytical technique. The strength of the Raman signal can be increased enormously if the molecules are physically close to certain metal surfaces, due to an additional energy transfer between the molecule and the surface electrons (plasmons) of the metal. To perform SERS, the analyte molecules are adsorbed onto an atomically roughened metal surface and the enhanced Raman scattering is detected. SERS can also be performed using silver colloids in solution.

The Raman scattering from a molecule or ion within a few Angstroms of a metal surface can be 10³ to 10⁶ fold greater than in solution. For near visible wavelengths, SERS is strongest on silver, but is readily observable on gold, copper and aluminium as well. Recent studies have shown that a variety of other metals may also give useful SERS enhancements.

The SERS effect is in essence a resonance energy transfer between the molecule and an electromagnetic field near the surface of the metal. The electric vector of the excitation laser induces a dipole in the surface of the metal, and the restoring forces result in an oscillating electromagnetic field at a resonant frequency of this excitation. The strength and frequency of this resonance is determined mainly by the free electrons at the surface of the metal (the ‘plasmons’) determining the so-called plasmon wavelength, as well as by the dielectric constants of the metal and its environment. Molecules adsorbed on or in close proximity to the surface experience an exceptionally large electromagnetic field in which coupling to vibrational modes normal to the surface are most strongly enhanced. This is the surface plasmon resonance (SPR) effect, which enables a through-space energy transfer between the plasmons and the molecules near the surface. The intensity of the surface plasmon resonance is dependent on many factors including the wavelength of the incident light and the morphology of the metal surface, since the efficiency of energy transfer relies on a good match between the laser wavelength and the plasma wavelength of the metal.

To increase the enhancement even further, a chromophore moiety may be used to provide an additional molecular resonance contribution to the energy transfer, a technique termed surface enhanced resonance Raman spectroscopy (SERRS). The intensity of a resonance Raman peak is proportional to the square of the scattering cross section of the molecule. The scattering cross section is, in turn, related to the square of the transition dipole moment, and therefore usually follows the absorption spectrum. If the incident photons have energies close to an absorption peak in their absorbance spectrum, then the molecules are more likely to be in an excited state when the scattering event occurs, thereby increasing the relative strength of the anti-Stokes signal. A combination of the surface and resonance enhancement effects means that SERRS can provide a huge signal enhancement, typically of 10⁹ to 10¹⁴ fold over conventional Raman spectroscopy.

In addition to resonance enhancement for Raman scattering, there have recently been descriptions of resonance de-enhancement, in which the Raman signal is reduced in intensity by a resonance energy transfer mechanism. Under specific conditions, an excited energy state close in energy to that of interest can produce a decrease in Raman scattering. In this situation, the Raman intensity is proportional to the square of the sum of the cross sections, and if they are of opposite signs then destructive interference can occur, resulting in the observed resonance de-enhancement. This provides an alternative metric for use in a Raman-based detector system: signals from a particular Raman-active chromophore may be selectively removed from the Raman spectrum by using a laser frequency that promotes this de-enhancement effect.

Surface enhanced Raman spectroscopy and its' extension, surface enhanced resonance Raman spectroscopy are gaining in popularity as quantitative bioanalytical tools. Both techniques rely to a large degree on an interaction between the ‘plasma’ of mobile conduction electrons at the surface of a metal (the plasmons) and molecular species close to that surface. This interaction results in a substantial enhancement of Raman scattering at specific vibrational energies, yielding a strong spectral signal in the Raman scattered light.

Until recently, a controversy surrounded the understanding of the enhancement mechanisms. The two major factions disagreed on the partitioning of the greater than 10⁶ enhancement factor between the chemical enhancement mechanism and the electromagnetic enhancement mechanism. The chemical enhancement mechanism, now thought to contribute an enhancement factor of 10², asserts that a charge-transfer state is created between the metal and adsorbate molecules. This mechanism is site-specific and analyte dependent. The molecule must be directly adsorbed to the surface in order to experience the chemical enhancement. The electromagnetic enhancement mechanism contributes a greater than 10⁴ times enhancement over normal Raman scattering. In order to understand the electromagnetic enhancement, one must consider the size, shape, and material of the surface's nanoscale roughness features. If the correct wavelength of light strikes a metallic roughness feature, the plasma of conduction electrons will oscillate collectively. Because this collective oscillation is localized at the surface of this plasma of electrons, it is known as a localized surface plasmon resonance (LSPR). The LSPR allows the resonant wavelength to be absorbed and scattered, creating large electromagnetic fields around the roughness feature. If a molecule is placed within the electromagnetic fields, an enhanced Raman signal is measured.

The strength and local density of the field is determined by a variety of parameters. The wavelength of the scattered light determines its energy, and the composition and morphology of the metal determines the strength and efficiency with which the surface plasmons couple to the photon energy. Other factors, such as the relative dielectric properties of the metal and analyte solution, also have strong contributions to the effect. In addition, the efficiency of energy transfer between the field and any molecules close to the metal surface is also determined by resonant energetic states in the molecule itself, including, for example, specific vibrational modes in the infrared spectral region and electronic energy transitions in the ultraviolet. This is the mechanism by which SERRS gains performance over conventional SERS.

We have appreciated the problem that the Raman scattering effect, even using surface enhanced Raman scattering (SERS), provides a small amount of Raman scattered radiation in comparison to Rayleigh scattering (where the scattered photons have the same energy as the incident photons). We have further appreciated that, because the Raman signal is therefore weak in comparison to noise, there is a need to introduce a mechanism to help distinguish the Raman signal from the noise.

### SUMMARY OF THE INVENTION

The invention is defined in the claims to which reference is directed.

An embodiment of the invention uses a SERRS-active labelling group, which is based on the formation of a co-ordination complex between a transition metal ion and suitable ligand groups to produce a dye for use in Raman spectroscopy.

The metal ion and suitable ligand groups are chosen such that the ligands, which are often fluorescent in their free state, are able to undergo an enhanced non-radiative decay/relaxation from their excited state upon complex formation, thereby forming strong chromophores whilst reducing the interference to the Raman signal from background fluorescence and enhancing the Raman scatter by an energy transfer mechanism. A complex may be formed by electrostatic attraction between the ligand and the ion or by hydrophobic attraction.

A chromophore is of course well known to the skilled person and is used herein to cover a group having specific optical characteristics. The term “dye” refers to a chromophore that has had one or more linking groups attached to provide some sort of functionality. Such functionalities could result, for example, from adding a metal surface seeking group, or a group to allow binding to an analyte. The chromophore should strongly absorb the excitation laser at wavelengths suitable for surface enhancement (the most popular Raman lasers are 514 nm, 532 nm, and 785 nm). This is in the green-red visible range, so traditional brightly coloured chromophores are found as a constituent of particularly good Raman-active dyes.

An analyte is any chemical that it is desired to detect or quantify. Examples of suitable analytes include: biological molecules (such as proteins, antibodies, nucleic acids, carbohydrates, proteoglycans, lipids, or hormones), pharmaceuticals or other therapeutic agents and their metabolites, drugs of abuse (for example amphetamines, opiates, benzodiazepines, barbiturates, cannabinoids, cocaine, LSD and their metabolites), explosives (for example nitroglycerine and nitrotoluenes including TNT, RDX, PETN and HMX), and environmental pollutants (for example herbicides, pesticides).

An analyte sample is any sample that it is desired to test for the presence, or amount, of analyte. There are many situations in which it is desired to test for the presence, absence, or amount, of an analyte. Examples include clinical applications (for example to detect the presence of an antigen or an antibody in a biological sample such as a blood or urine sample), to detect the presence of a drug of abuse (for example in an illicit sample, or a biological sample such as a body fluid or breath sample), to detect explosives, or to detect environmental pollutants (for example in a liquid, air, soil, or plant sample).

In addition to directly detecting analytes themselves, it is also possible to detect them indirectly by using a reporter molecule which is able to generate a detectable change in its' Raman signal in the presence of the analyte of interest. An example of this would be the displacement of a dye-labelled peptide from the antigen binding site of an analyte-specific antibody, thereby releasing free reporter molecules which are then able to interact with the SERRS-active metal surface. For our purposes, such reporter molecules can also be regarded as ‘analytes’.

The dye may bind to the analyte by a selective agent that is any agent that binds selectively to the analyte in the presence of the other components of the analyte sample, and under the conditions in which the detection method is carried out, so that the presence (or amount) of the analyte in the sample can be detected. The nature of the selective agent will of course depend on the identity of the analyte. In many cases, the selective agent will be an antibody. However, other suitable analyte binding partners may be used. For example, if the analyte is an antibody, the selective agent may be an antigen or antigen derivative that is selectively bound by the antibody. If the analyte is nucleic acid, the selective agent may be a nucleic acid, or a nucleic acid analogue, that hybridizes to the analyte nucleic acid.

The term “antibody” is used herein to include an antibody, or a fragment (for example a Fab fragment, Fd fragment, Fv fragment, dAb fragment, a F(ab′)2 fragment, a single chain Fv molecule, or a CDR region), or derivative of an antibody or fragment that can selectively bind an analyte to allow detection of the analyte.

It is possible that the analyte itself may be intrinsically Raman-active. In such embodiments the dye may be chemically identical to the analyte.

In general, it is expected that the components of the dye will be linked together by separate linkers. It will be apparent to the skilled person that there are many possible suitable linkers that could be used. The identity of the linkers will depend on the identity of the components of the dye. If the selective agent binding group comprises a peptide, it is advantageous if the linker is compatible with conventional peptide linking chemistry. For example, the linker may preferably comprise a single carboxylic acid group for reaction with the N-terminus of the peptide.

In some circumstances, depending on the particular components used, it may be possible to link two or more components of the dye together without use of a separate linker, for example by reaction between chemical groups of different components of the dye.

The components of the dye may be linked together in any order, provided that if the dye is bound to the surface by means of a metal surface-binding group, the dye is within the region near the metal surface.

The metal surface-binding group of a dye should be a group that binds preferentially (typically by adsorption) to the metal surface. In some circumstances, it may be desired that binding of the metal surface-binding group to the metal surface is sufficiently strong enough to immobilize the dye to the metal surface. The chemical nature of the metal surface-binding group will depend on the metal surface that is used. Suitable silver binding functional groups include groups having a heterocyclic nitrogen, such as oxazoles, thiazoles, diazoles, triazoles, oxadiazoles, thiadiazoles, oxathiazoles, thiatriazoles, benzotriazoles, tetrazoles, benzimidazoles, indazoles, isoindazoles, benzodiazoles or benzisodiazoles. Other suitable functional groups include amines, amides, thiols, sulphates, thiosulphates, phosphates, thiophosphates, hydroxyls, carbonyls, carboxylates, and thiocarbamates. Amino acids such as cysteine, histidine, lysine, arginine, aspartic acid, glutamic acid, glutamine or arginine also confer silver binding.

### BRIEF DESCRIPTION OF THE FIGURES

Embodiments of the invention will now be described, by way of example only, and with reference to the accompanying drawings, in which:

FIG. 1 shows various kinds of electronic excitations that may occur in organic molecules;

FIG. 2 shows the electronic energy transitions involved in fluorescence and phosphorescence;

FIG. 3 shows the electronic energy transitions involved in Raman Scattering;

FIG. 4 shows the various d orbitals;

FIG. 5A shows an octahedral molecular arrangement

FIG. 5B shows the change in the d orbital energy levels associated with an octahedral arrangement;

FIG. 6A shows a tetrahedral molecular arrangement

FIG. 6B shows the change in the d orbital energy levels associated with a tetrahedral arrangement;

FIG. 7A shows a square planar molecular arrangement

FIG. 7B shows the change in the d orbital energy levels associated with a square planar arrangement;

FIG. 8 shows the electronic energy levels for a typical organic molecule (phenanthroline) and the electronic energy levels for a metal ion/organic ligand complex;

FIG. 9 shows the emission spectrum of Phen in aqueous solution;

FIG. 10 shows the emission spectrum of [Fe(Phen)₃]²⁺ in aqueous solution with the addition of silver colloids under illumination at a wavelength of 532 nm;

FIG. 11 show the structure of tris-1,10-phenanthroline iron(II) [Fe(Phen)₃]²⁺;

FIG. 12 shows the possible arrangements of enantiomers and geometric isomers that may be formed from a central ion and three asymmetric ligands

FIG. 13 shows a possible diagrammatic structure of a dye incorporating a chromophore and functional linker groups;

FIG. 14 shows an example of a possible ligand for use in a complex according to the invention;

FIG. 15 shows an alternative arrangement for labelling the analyte;

FIG. 16 shows the predicted arrangement of an assembled complex in accordance with the invention;

FIG. 17 shows the ground and excited orbitals for [Fe(Phen)₃]²⁺;

FIG. 18 shows a reaction for producing an alternative ligand for use in the invention;

FIG. 19 shows the structure of a complex formed from ligand A of FIG. 18 and iron(II) ions;

FIG. 20 shows a reaction demonstrating the addition of Benzotriazole to Phenanthroline;

FIG. 21 shows the structure of a dye formed by a combination of the reactions shown in FIGS. 18 and 20 comprising a chromophore, a peptide/nucleic acid linking site and three benzotriazole silver-binding groups;

FIG. 22 shows an example of a tripedal ligand

### DESCRIPTION OF EMBODIMENTS OF THE INVENTION

The embodiments described feature an improved dye for use in spectroscopy. The invention uses a transition metal/ligand complex to produce a dye with optimal characteristics for spectroscopy, particularly Raman spectroscopy and its derivatives SERS and SERRS. As well as conferring the optical absorption peak necessary for resonance Raman spectroscopy, the lower fluorescence afforded by such a complex reduces interference to the Raman signal from the fluorescence background and can further enhance the Raman intensity by enabling a transfer of energy from the mechanism responsible for generating fluorescence to the mechanism responsible for generating Raman scatter. Fluorescence is an undesirable characteristic for a Raman dye as it essentially produces background noise that obscures the Raman signal.

### Optical Absorbance

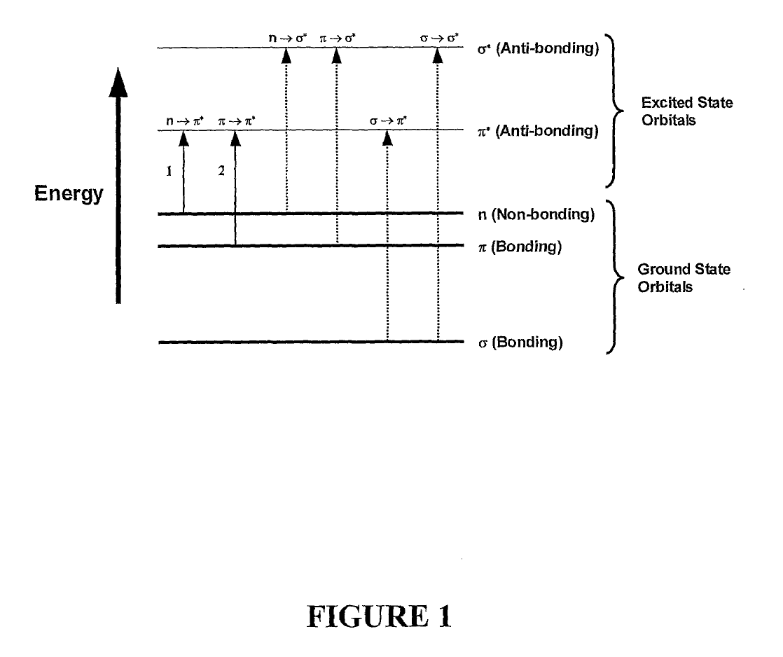

The visible region of the spectrum (400 to 800 nm) comprises photon energies between 150 and 300 kJ.mol−1, and the near ultraviolet region (down to 200 nm) extends this energy range to around 600 kJ.mol−1. All of these energies are sufficient to promote or excite a molecular electron to a higher energy orbital. FIG. 1 shows the various kinds of electronic excitation that may occur in organic molecules.

Of the six transitions shown in FIG. 1, only the two lowest energy ones 1, 2 (indicated with solid arrows) can be achieved by the energies available in the 200 to 800 nm spectrum. Both of these involve a transition to an anti-bonding π orbital (3), and therefore organic molecules having extensive π systems are particularly good chromophores.

When chromophore molecules are exposed to photons having an energy matching a possible electronic transition within the molecule, some may be absorbed as the electron is promoted to a higher energy orbital. Energetically favoured electron promotion will typically be from the highest occupied molecular orbital (HOMO) to the lowest unoccupied molecular orbital (LUMO). The concept of molecular orbitals is well known and they can also be thought of as electron energy levels within the molecule.

### Fluorescence and Phosphorescence

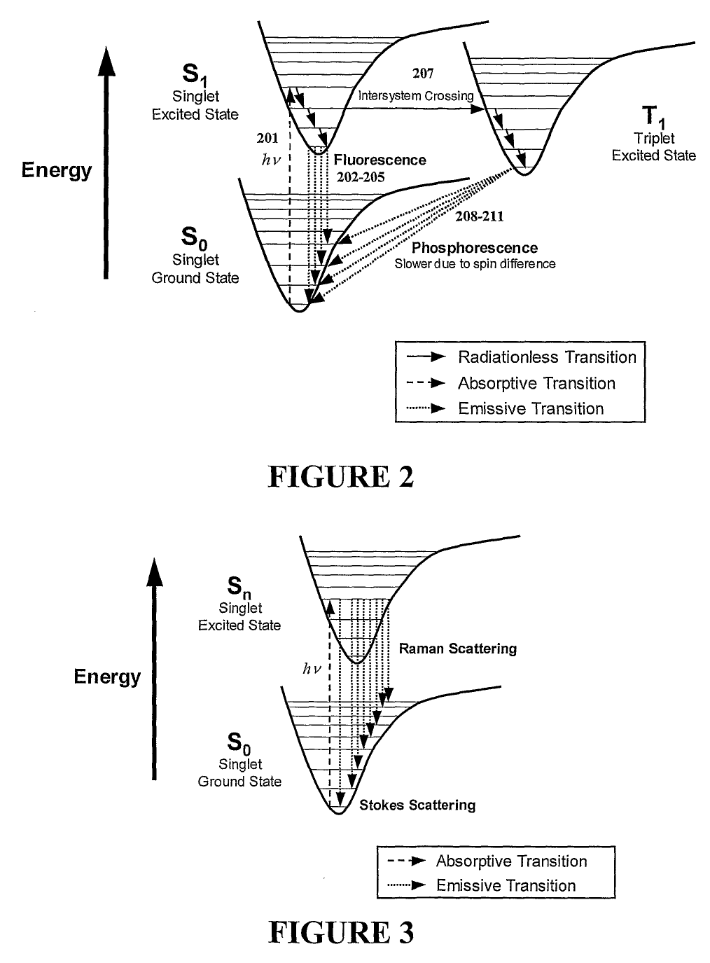

Fluorescence and phosphorescence are related phenomena in which light energy is absorbed and re-emitted with a characteristic emission profile. The shape of this emission profile is independent of the excitation wavelength, but its intensity follows the absorbance profile of the compound. The electronic energy transitions involved are shown in FIG. 2.

FIG. 2 shows the ground, singlet excited and triplet excited states of a general fluorescent/phosphorescent molecule and how transitions between these states can generate either fluorescence or phosphorescence. The y-axis indicates the energy of the various states; the x-axis indicates the “Q” value, which can be thought of as the length of the bonds of a molecule. In fluorescence, the spin multiplicities of the ground and emissive excited states are the same. In most organic molecules, the ground state is a singlet state (i.e. all electron spins are paired). Fluorescence occurs when a molecule has been promoted to an excited singlet state by an absorption transition 201, and then decays back to the ground singlet state by emission transitions 202-205.

Phosphorescence is a light emission process in which the excited and ground states have different spin multiplicities. In an organic molecule, whose ground state is a singlet, there are several energetically accessible triplet excited states (with two unpaired spins). Following excitation into the multiplicity of singlet-excited states by an absorption transition 201, a molecule may undergo non-radiative decay (inter-system crossing 207) to a triplet-excited state. The triplet state may then emit a photon by a radiative transition 208-211 as the molecule decays back to the ground state.

The energy curves of FIG. 2 show various microstates relating to vibrational and rotational states of the molecule. An electron at room temperature has an energy of approximately 0.04 eV and the separation between these microstates is, on average, approximately the same. Electrons will generally therefore have access to neighbouring states and will be able to transition between them. Transitions between microstates are non-radiative and as an electron passes down through the states, the energy is transferred to rotational and vibrational modes of the molecule itself. Fluorescence and phosphorescence generally occur only from the first excited singlet/triplet state (that is, the excited singlet/triplet state of lowest energy), irrespective of which excited singlet state was initially produced by absorption.

Because they involve the transition from the lowest energy band of the excited state to energy bands of the ground state, the shapes of the fluorescence and phosphorescence emission profiles do not change with different illumination wavelengths. Their intensities, however, are dependent on the efficiency by which photons are absorbed to generate the excited states, and so the fluorescence and phosphorescence emission intensities follow the absorbance profiles of the molecules.

Typically a triplet-excited state will be of a slightly lower energy than the singlet excited state. Intersystem crossing of an electron from the singlet molecular excited state to the triplet molecular excited state (as shown in FIG. 2) is possible when it is energetically favourable for the electron to do so. That is, when the energy difference between one microstate and the next consecutive microstate of a lower energy in the singlet state is bigger than that between said microstate and a microstate in the triplet state. For an electron to be able to move between microstates, or to undergo intersystem crossing, without emitting a photon the energy difference between consecutive states must be around k_{b}T or less (where k_{b} is the Boltzman constant and T is the temperature of the electron).

The singlet-excited states, which are responsible for the fluorescence of organic molecules, have finite lifetimes, typically measured in nanoseconds. Phosphorescence occurs over a longer timescale than fluorescence since to decay from the triplet excited state back to the singlet ground state requires the electron to flip its spin (also known as a spin transition). The probability of an electron flipping its spin is thermally dependant and as a result the triplet excited states have much longer lifetimes, often milliseconds or longer.

### Crystal Field Splitting

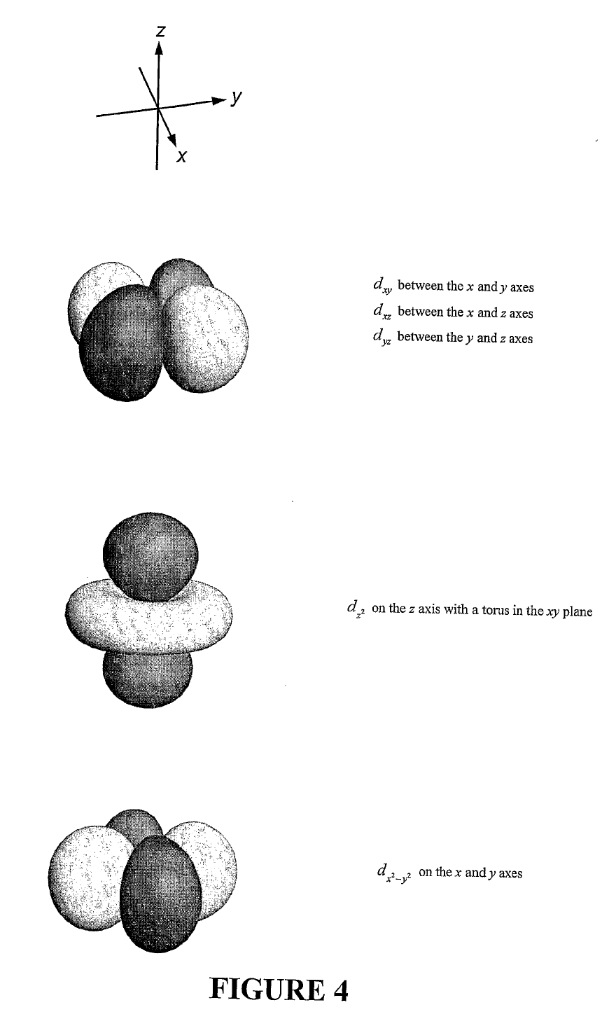

In a free atom or ion, all of the d orbitals have the same energy because the only difference between them is their orientation. However, in a molecule or complex, the outermost electrons may interact with electrons from neighbouring atoms if they are oriented correctly. The orientations and shapes of the five d orbitals are shown in FIG. 4.

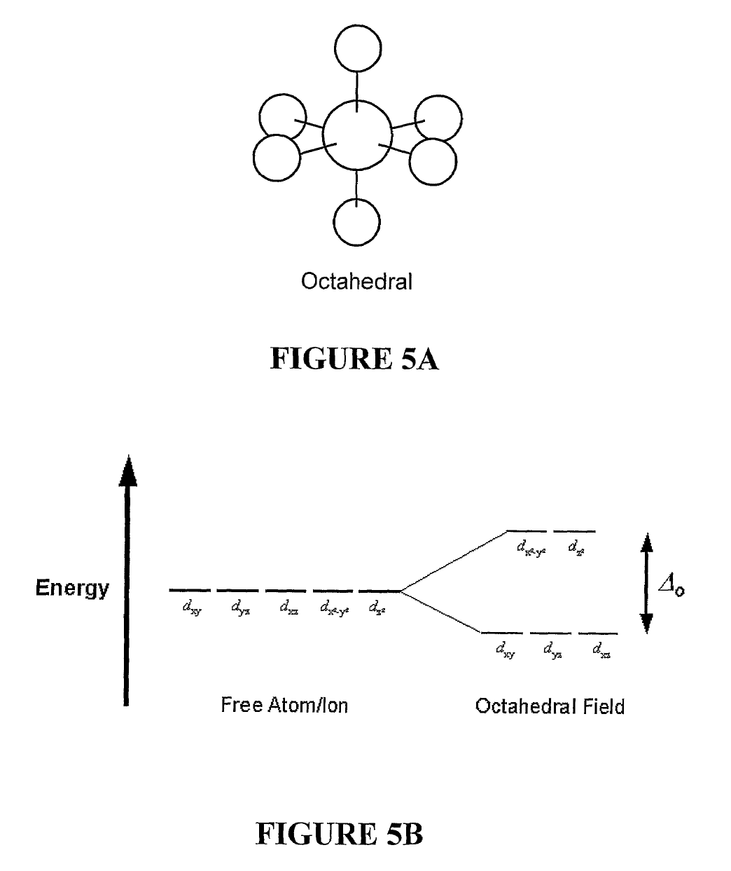

In an octahedral field such as that shown in FIG. 5A, six atoms interact with the central atom, one on each side of all three axes. The electrons of these other atoms will repel the d orbitals that lie on the axes (d_{z}_{²} and dₓ_{²}_{-y}_{²}). The requirement for conservation of energy means that if these two orbitals are destabilized (i.e. higher in energy) then the other three orbitals (d_{xy}, d_{xz}, and d_{yz}) must be stabilized (lower in energy), so the net effect is no change in energy. The energy difference between the low energy d orbitals (d_{xy}, d_{xz}, and d_{yz}), and the high energy ones (d_{z}_{²} and dₓ_{²}_{-y}_{²}) is the crystal field splitting energy, Δₒ (where the ‘o’ subscript indicates the octahedral geometry). This energy splitting is represented diagrammatically in FIG. 5B.

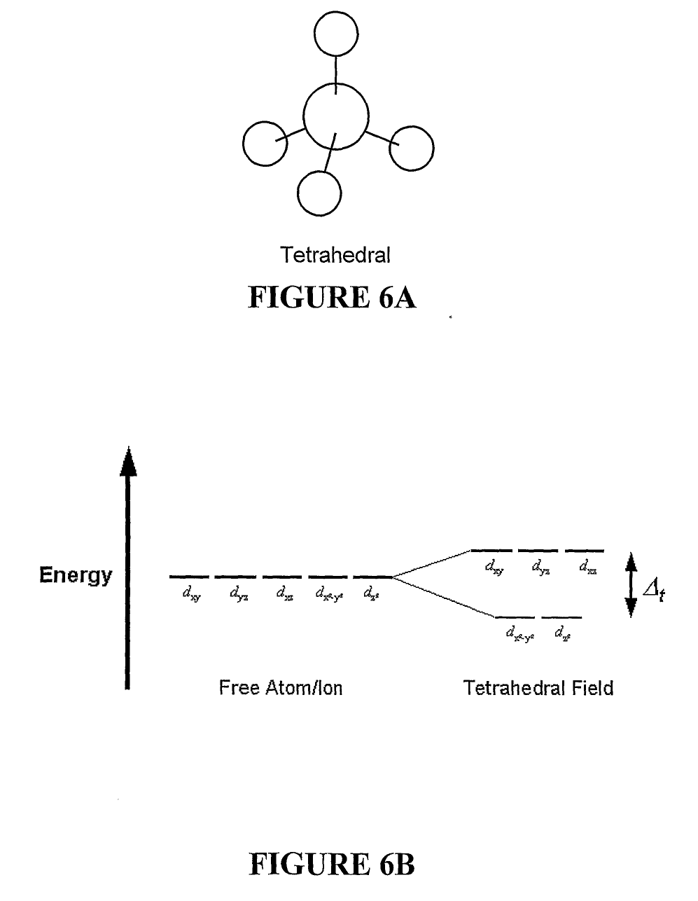

In a tetrahedral field such as that in FIG. 6A, four interacting atoms are located between the axes. This means that the d_{z}_{²} and dₓ_{²}_{-y}_{²} orbitals are stabilized and the d_{xy}, d_{xz}, and d_{yz} orbitals are destabilized. The tetrahedral crystal field splitting energy, Δₜ, therefore adopts the opposite arrangement of the octahedral arrangement (see FIG. 6B).

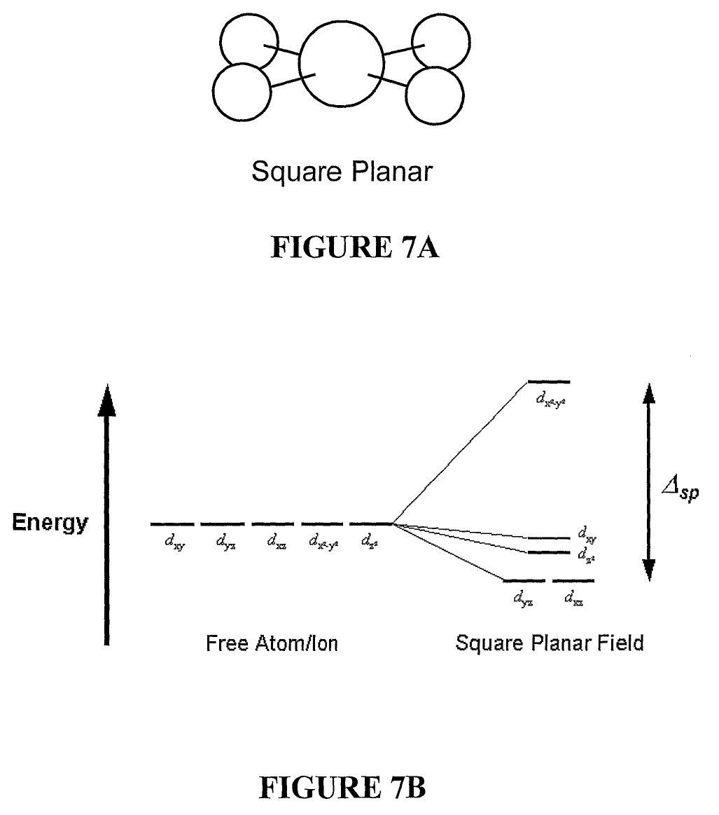

An alternative geometry for ligation by four atoms is square planar, shown in FIG. 7A. A square planar field is like an octahedral field, but missing atoms along one axis. Consequently, each level of the octahedral arrangement is re-split. The d orbitals therefore adopt the energetic configuration as shown in FIG. 7B. The square planar crystal splitting energy is referred to as Δₛₚ.

The magnitude of the split depends on the type of splitting (as a rule, Δₒ>Δₜ), the type of atom being split and the type of atom responsible for the splitting. Because Δₜ is relatively small, it is usually more energetically favourable for an electron in a tetrahedral geometry to go to a higher-energy d orbital than to pair up with a spin partner. With an octahedral geometry, it depends on the magnitude of Δₒ whether the electron would prefer to pair (when Δₒ is larger) or go to the higher orbital (when Δₒ is small). Compounds where the electrons prefer to pair are called low-spin. Compounds where electrons prefer a higher-energy orbital are called high-spin.

The splitting of the d orbitals leads to the introduction of an electronic transition that is not present in the free metal atom. For example, the formation of a complex which causes a d orbital splitting of 3.734×10⁻¹⁹ J will result in an electronic transition that leads to the absorption of light with a wavelength of 532 nm, which is in the middle of the visible range. Many transition metal complexes undergo d orbital splitting of around this magnitude, leading to their characteristic bright colours.

One way to achieve the formation of a chromophore with the desired characteristics is to select combinations of metals and ligands able to form metal-ligand charge transfer complexes (MLCT complexes). MLCT complexes are defined as a pair comprising a metal ion and a ligand where one member of the pair is electron-donating and the other is electron-accepting and where there is a partial transfer of electronic charge from the donor to the acceptor in an excited electronic state. MLCT complexes typically have an electronic energy transition between the excited molecular state and the ground state, which provides both an energy gap suitable for excitation in the UV/visible region and an electronic transition pathway that promotes non-radiative thermal relaxation of the excited state.

The non-radiative electronic transition pathway provided by the MLCT complex is a result of the chemical bond formed between the ion and the ligand. The bond provides a thermally accessible electron level between the ground state electron level of the complex and the excited electron level of the ion and allows an electron to thermally relax to the ground state without emitting a photon. This non radiative decay can occur when the energy differences between the lowest unoccupied electron level of the ligand and the thermally accessible electron level, and the thermally accessible electron level and the ground state electron level are within k_{b}T of each other. The term “thermally accessible” is known to the skilled person and includes an energy level that is within k_{b}T of the energy level occupied by an electron as in the example described above.

By selecting the appropriate transition metal and ligands, an MLCT complex can be produced such that the HOMO, a ground state, is associated with the metal ion's d_{z}_{²} orbital, whilst the LUMO, an excited state, is associated with the π* orbital of the ligand, which is also a triplet state. Since the d_{z}_{²} orbital of the metal ion is the HOMO and the π* orbital of the ligand is the LUMO, the ground state electron density is essentially concentrated on the Fe²⁺ ion. The metal ion absorbs the photon energy and an electron is promoted to an excited energy state of the ion before transferring to the LUMO of the ligand. Transfer to the LUMO of the ligand can occur if the energy of the ion's excited level is within k_{b}T of the LUMO energy level. This means that the electron is actually physically shifting position (from the metal ion to the ligand) within the MLCT as well as energy states.

The result of the electron actually physically shifting position is an increase in the thermal motion of the complex and a further enhancement of the Raman signal.

An increase in the temperature/thermal motion of the molecule increases the availability of energy microstates to electrons (microstates such as those shown in FIG. 2). In resonance Raman spectroscopy, the energy of an incoming photon is matched as closely as possible with an electronic transition of the molecule. An electron, having absorbed a photon “tuned” to the energy of a particular electronic transition, will be more likely to promoted to a “real” microstate (as opposed to a virtual state), as is necessary for resonance Raman spectroscopy, if there are more microstates available of approximately the same energy as the electronic transition of the complex. Therefore, the probability of transitions occurring in accordance with the resonance Raman effect is increased. It should be noted that when performing resonance Raman spectroscopy in practice the incoming, or illuminating, radiation need only be of an energy sufficient to excite a substantial proportion of electrons from a ground state of the molecule to an excited electron level. The required energy is generally considered to be of within k_{b}T of the energy difference between the excited energy level of the molecule in question and the ground state.

By complexing a ligand with a metal ion and matching the energy levels of the π* orbital of the ligand with that of the destabilized d orbital of the metal ion the triplet-excited state is stabilised above the singlet-excited state. This promotes the intersystem crossing of electrons into the triplet state and results in the fluorescence mechanism becoming a quantum mechanically forbidden transition and is then said to be quenched. By complexing a suitable ligand with a suitable ion a chemical bond may be formed that provides an additional energy level located between the LUMO and the ground state of the complex. This additional energy level allows an electron to thermally relax from the LUMO to the ground state without radiating a photon.

The reduction of fluorescence has two benefits for Raman spectroscopy. Not only is the number of fluorescently scattered photons reduced, but a proportion of the energy ‘drained’ by the non-radiative decay may be transferred to either thermal motion or alternative electronic transitions in the scattering molecule, leading to a further enhancement of the Raman signal over and above that from conventional Raman spectroscopy. The ligand ion complex has thermal vibrational modes available to accept energy resulting from the thermal relaxation of the electron. That is to say, ligand ion complex as provided in accordance with the invention has vibrational modes that are thermally accessible to (within k_{b}T of) the energy of an electron transitioning between the lowest unoccupied electron energy level of the ligand and the thermally accessible electron energy level and between the thermally accessible electron energy level and the ground state electron energy level. When an electron that would otherwise take part in the fluorescence mechanism is provided with an alternative, non-radiating, relaxation path as in accordance with the invention, energy will be passed from the electron into these thermal vibrational modes and increase the thermal energy of the complex with a resulting increase in the Raman signal.

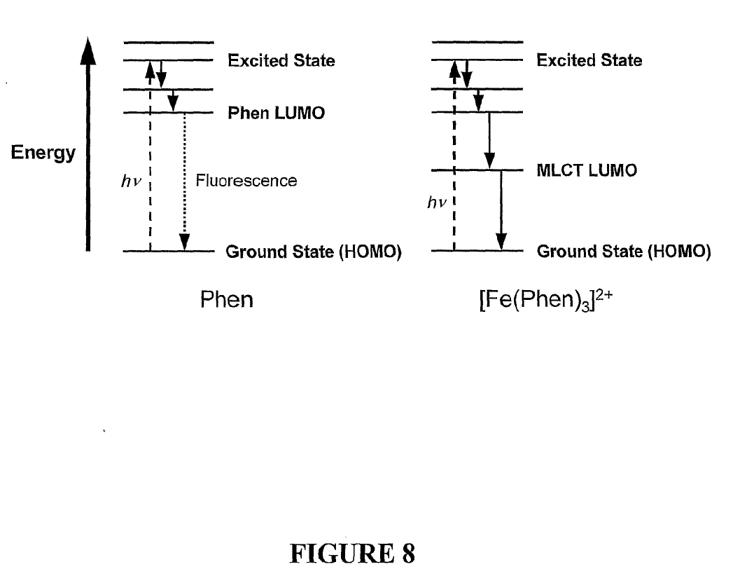

FIG. 8 shows a typical example of the molecular energy levels for Phen and for the MLCT complex [Fe(Phen)₃]²⁺. The bonds between the Fe²⁺ transition metal and the Phen ligands introduce an additional electronic energy level between the HOMO and the LUMO. When an electron moves into the triplet-excited state it will move down to the lowest of the vibrational microstates but is not able to return to the ground state without flipping its spin. This is the mechanism of phosphorescence. The additional energy level between the HOMO and LUMO makes it thermodynamically favourable for the transition from the triplet excited state to the ground state to be non radiative since the existence of the thermally accessible electron energy level provides an alternative relaxation pathway for an electron in an excited state and reduces the probability of a photon being emitted.

For a complex according to the invention an excited electron which transfers to the lowest unoccupied electron level of the ligand can relax via the thermally accessible electron level to the ground state of the complex without the need for a spin transition. If the thermally accessible electron level between the ground state electron level of the complex and the excited electron level of the ion is unoccupied by electrons, an electron thermally relaxing via the non radiative path does not need to flip its' spin. The same applies if the thermally accessible electron level between the ground state electron level of the complex and the excited electron level of the ion is occupied by an electron provided that the spin of this electron is the opposite spin to that of the relaxing electron in the lowest unoccupied electron level of the ligand.

When moving from the excited ion energy level to an energy level of the ligand as described above, it is preferred that the electron moves to the LUMO of the ligand. The electron must be in the LUMO before it can thermally relax along the alternate thermal relaxation path. If the electron were to move into a microstate above the LUMO it would need to thermally relax to the LUMO before it can make use of the alternate thermal relaxation path. Such a time delay is undesirable as it would allow the complex to relax from its' excited state, which would result in an increased probability of the complex radiating.

Transitions in the optical range occur between d orbitals for transition metals and between π and π* orbitals for organic molecules. A complex formed between a transition metal and organic molecule will have both mechanisms available to it provided the energy difference between π and π* orbitals of the organic molecule are matched with the d orbital energy splitting. It is possible to use orbitals other than the d orbitals of transition metals or π orbitals of organic molecules provided the energy gaps can be matched to the RS laser being used. The abovementioned energy gaps are convenient for a typical laser of 532 nm wavelength.

### Phen/Iron Embodiment

One particular embodiment of the invention involves forming a complex of iron with 1,10-phenanthroline (Phen) and will now be described. Phen forms a pale yellow aqueous solution which is fluorescent under 532 nm illumination. Phen is also well known as a redox indicator for Fe²⁺ or Fe³⁺, forming [Fe(Phen)₃]²⁺ (coloured deep red) or [Fe(Phen)₃]³⁺ (coloured light blue) respectively.

The HOMO of the Phen is delocalised over much of the molecule, predominantly as a conjugated π system. The lowest singlet and triplet-excited states (LUMOs) are also π systems with different distributions of the electron density. Optical absorption by Phen therefore probably involves a π→π* transition.

Phen readily forms a complex with iron(II) according to the following reaction:

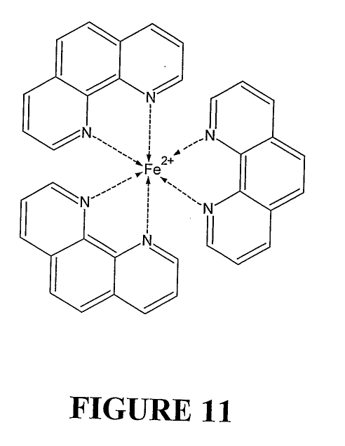

Fe²⁺+3 Phen→[Fe(Phen)₃]²⁺

[Fe(Phen)₃]²⁺ (specifically tris-1,10-phenanthroline iron(II)) has the structure shown in FIG. 11. The central Fe²⁺ ion is surrounded by the three Phen groups in an octahedral arrangement.

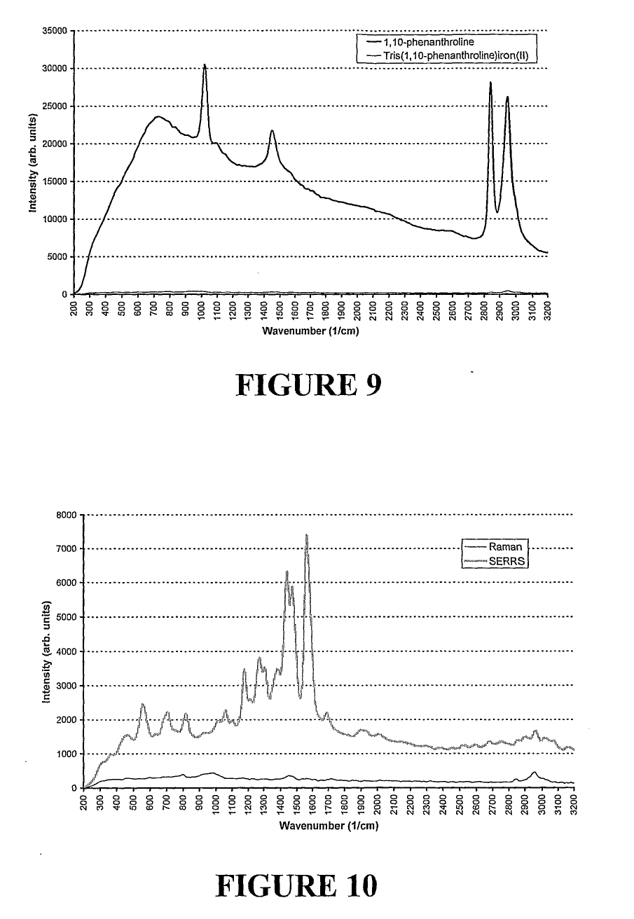

The bold line of FIG. 9 shows the emission spectrum of Phen in aqueous solution under illumination at a wavelength of 532 nm. The broad baseline “hump” feature is due to fluorescence, and the sharper peaks overlaid on this are Raman-scattered photons. On addition of iron(II) chloride, the [Fe(Phen)₃]²⁺ complex is formed, changing the pale yellow solution to a deep red colour and reducing hugely the emitted signal (the thin line close to the x axis). This shows that by forming the complex with Fe²⁺, the Phen fluorescence is indeed vastly reduced.

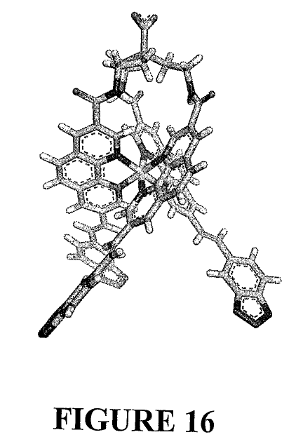

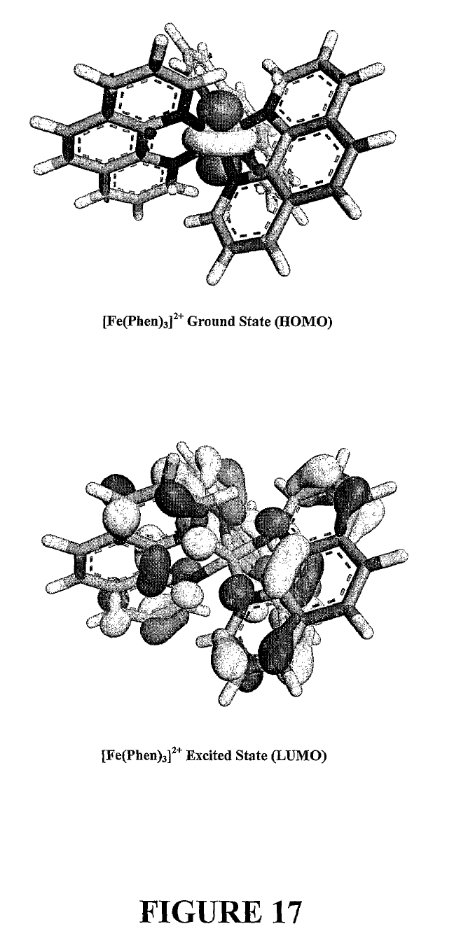

A quantum mechanical analysis of the molecular orbitals of the [Fe(Phen)₃]²⁺ complex shows which orbitals are involved in this phenomenon. As described above, the initial absorption event is from a singlet ground state, the highest occupied molecular orbital (HOMO), and that any fluorescently emitted photons will come from a transition between the lowest unoccupied molecular orbital (LUMO) and this ground state. These orbitals are shown above for [Fe(Phen)₃]²⁺ in FIG. 16.

The HOMO is essentially the d_{z}_{²} orbital of the Fe²⁺ ion (with very minor contributions from the Phen groups), and the LUMO is a delocalised π system limited to the ring atoms in the six ‘pyridine’ systems, which are co-ordinated to the Fe²⁺. It should be noted that the electron density of the LUMO on each of the Phen molecules in the complex is essentially the same as the LUMO in the triplet excited state of free Phen.

Since the HOMO is confined to the Fe²⁺ ion, and the LUMO is confined to the Phen ligands, an electron jumping between these orbitals would transfer a charge between the Fe²⁺ ion and the π* system of the ligands, supporting the proposed MLCT mechanism. The wavelength of light needed to cause this transition is approximately 510 nm.

Whilst the embodiment described uses 1,10-phenanthroline it should also be noted that the absence of any LUMO electron density on the 5- and 6-carbon atoms of the Phen ligands suggests that 2,2′-bipyridine (‘Bipy’), a related molecule that lacks these atoms, would behave in a very similar fashion to Phen. Similarly, 5,6-dihydro-1,10-phenanthroline and its' derivatives would also be suitable.

The experiment described above indicates the behaviour of the system in bulk solution, where there is no possibility of a surface enhancement effect, and hence is an example of resonance Raman spectroscopy (RRS) since the [Fe(Phen)₃]²⁺ complex has an absorption peak (at 510 nm) close to the illumination wavelength (532 nm). By adsorbing the complex onto a silver surface (e.g. by adding silver colloid or exposing the solution to a deposited silver surface), then the more sensitive surface-enhanced resonance Raman spectroscopy (SERRS) detection method may be employed.

FIG. 10 shows the emission spectrum of [Fe(Phen)₃]²⁺ in aqueous solution with the addition of silver colloids under illumination at a wavelength of 532 nm. A much stronger SERRS signal is produced than the solution Raman signal without silver colloids, indicating that a surface enhancement effect is being achieved. It should be noted that there is very little fluorescence background. This demonstrates that [Fe(Phen)₃]²⁺, which was selected according to the concepts outlined in this invention, is exhibiting precisely the characteristics intended. Using this technique the Raman signal is so strong that this effect is visible to the naked eye.

### SERRS Labels

We have appreciated that the model complex [Fe(Phen)₃]²⁺ shows promising characteristics for a SERRS chromophore. In order to make such a complex into a viable SERRS labelling group functional groups are required, as is known in the art, through which conjugation to the analyte may be achieved. In addition, whilst we have demonstrated that it does exhibit SERRS activity, the addition of specific surface-binding groups would confer an even greater surface enhancement effect.

Derivitised phenanthroline and bipyridine groups may serve as the starting point from which to construct a suitably functional SERRS labels. For example, compound (xyzxyz) contains a carboxylic acid group which confers a site suitable for conjugation to peptides using conventional coupling chemistry, and also a benzotriazole group which would confer strong binding to a silver surface. This compound would form a complex with Fe²⁺ in the same way that Phen does, by coordinating the Fe²⁺ ion via the nitrogen atoms on the phenanthroline group.

A complex formed from Fe²⁺ and three of these asymmetric ligands would result in a variety of enantiomers and geometric isomers being formed (FIG. 11). Half of these would have the surface-binding groups arranged in a sub-optimal conformation (only the left-most and right-most structures of FIG. 11 would have all three metal-binding groups pointing towards the surface).

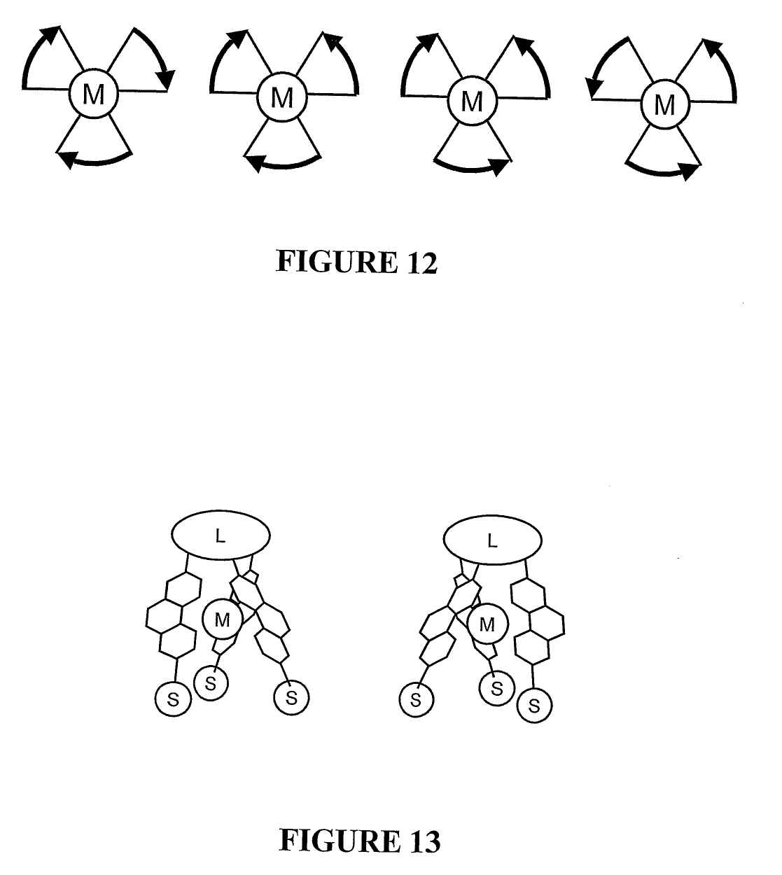

This situation can be avoided by constraining the orientation of the ligands around the metal ion (‘M’ in FIG. 11). If each of the ligand groups is attached to a common linker (‘L’) at one end and the surface binding group (‘S’) at the other, then they will self-assemble with the metal ion to form a tripodal structure as indicated in FIG. 12. It should be noted that both molecules in FIG. 12 constitute dyes in that there is a chromophore present along with one or more functional groups. Removal of either the surface binding groups (S), or the linker (L) would still leave the molecule as a “dye”, however removal of both these functional groups would leave only the chromophore and it would no longer constitute a dye as such.

The complex may form two enantiomers (the mirror images shown in FIG. 12), but both will still have the surface binding groups oriented correctly. The linker group must not substantially interfere with the formation of the metal ion complex. In one example described below and shown in FIG. 13, the ligand has a phenanthroline complexing group, a benzotriazole group for surface binding, and a carboxylic acid for conjugation to the linker. To maximise the SERRS chemical enhancement, the chromophore group should be attached to the surface via a delocalised bond system. The trivalent linker has three amino groups, one for attachment to each ligand group, and a further carboxylic acid group which provides the conjugation functionality needed for attachment to the analyte molecules.

The assembled complex is predicted to adopt a conformation as shown in FIG. 15 (only one enantiomer is shown).

The ligand groups may carry additional chromophores. For example, the benzotriazole groups are connected to the phenanthroline groups in the above molecule by ethene spacers. These could easily be replaced by azo groups. The resulting complex would then have four chromophores—the [Fe(Phen)₃]²⁺ group plus the three azo groups. Depending on the specific choice of chromophores, a further signal enhancement through an interchromophore transfer mechanism may also be achieved.

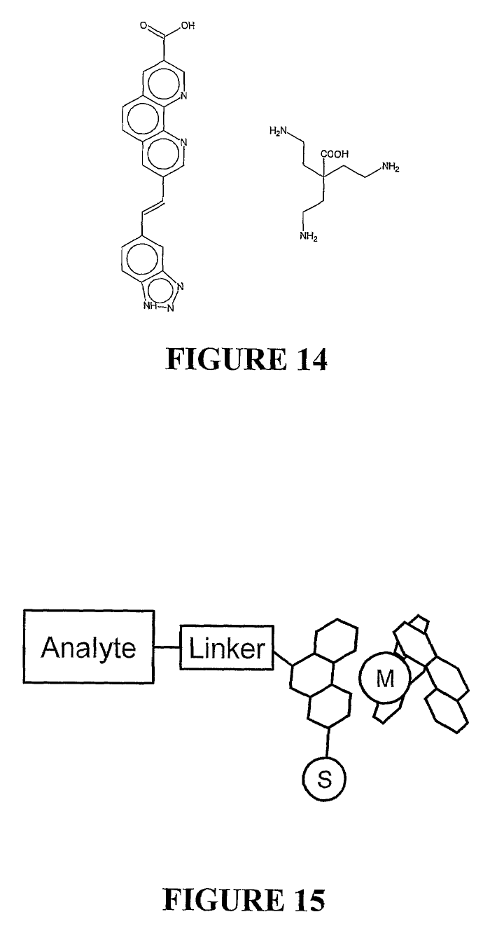

An alternative strategy for labelling the analyte would be to covalently attach it to one ligand group (possibly via a spacer/linker) and to assemble the complex by the addition of the metal ion and extra free ligand groups (FIG. 14). If the ligand groups carry one or more functional groups able to provide unique peaks in the resulting Raman emission spectra, this would provide a means for generating a variety of related SERRS tags for multiplex applications. Suitable Raman-active groups may include halogen atoms, as in our previous halometallocene patent, although the addition of these directly to the phenanthroline system is predicted to interfere with the energetics of the delocalised system to such an extent that they may make relatively poor chromophores.

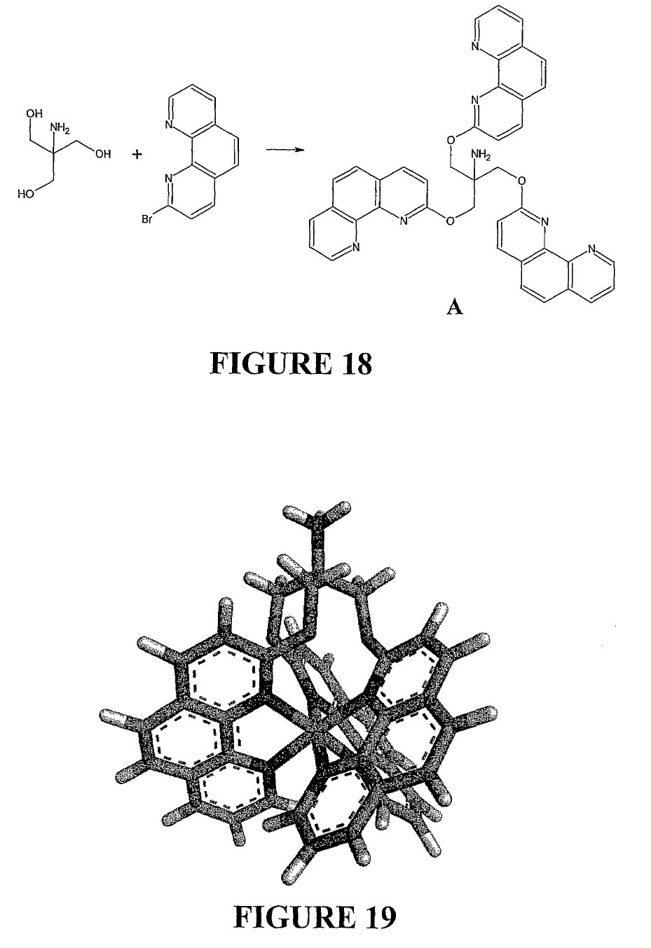

An alternative series of dyes according to the invention is based on the synthesis outlined below. Starting from three equivalents of 2-bromo-1,10-penanthroline and one equivalent of 2-amino-2-(hydroxymethyl)propane-1,3-diol, the tripedal ligand A (as shown in FIG. 18) can be produced, for example by stirring at 0° C. for 24 h in dry N,N-dimethylformamide in the presence of nine equivalents of NaH. A similar reaction can be performed using 6-bromo-2,2′-bypyridine or 2-bromo-5,6-dihydro-1,10-phenanthroline to give structurally related chromophore centres. Similar reactions can also be performed using starting materials with different halogens.

Ligand A will form a stable complex with iron(II) ions, to give a complex with the central ion in an octahedral geometry (as shown in FIG. 19). The complex will form spontaneously upon mixing with iron(II) chloride solution, and the rate of this may be enhanced by heating if necessary.

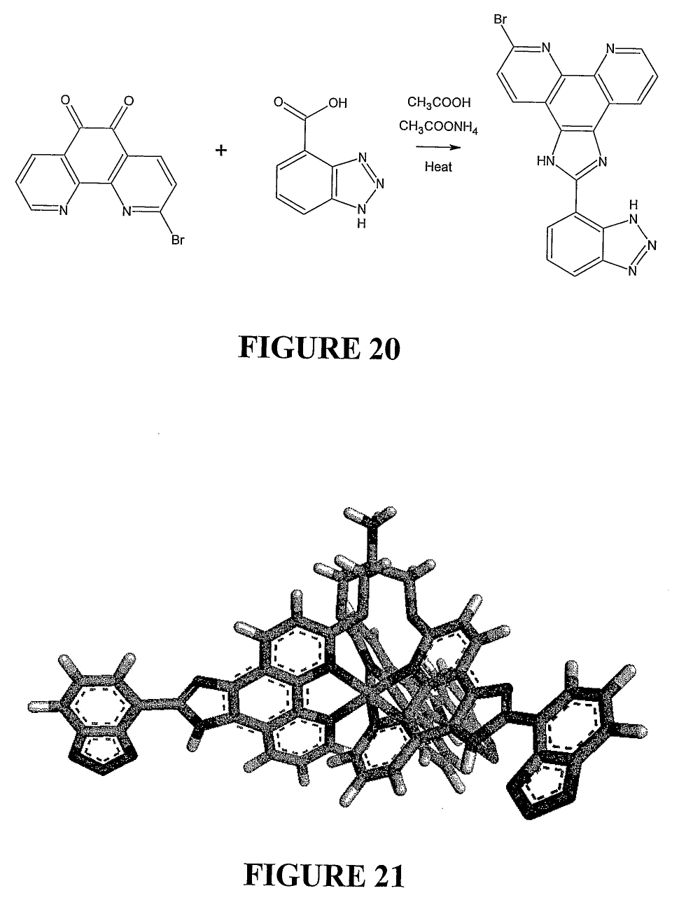

This complex comprises a chromophore and a reactive amine suitable for further derivatisation to form conjugates with peptides or nucleic acids, for example. The chromophore moiety has a charge of 2⁺, and will have an intrinsic affinity for binding to SERRS active metal surfaces. This affinity can be increased by the addition of metal-binding groups such as benzotriazole as shown in the reaction of FIG. 20.

A combination of these reactions will yield a SERRS dye comprising a chromophore, a peptide/nucleic acid linking site and three benzotriazole silver-binding groups.

The spacing of the benzotriazole groups from the chromophore centre and the orientation of these groups when bound to the metal surface can be controlled by using starting materials with different numbers and types of atom between the benzotriazole phenyl ring and the carboxylate group. The orientation of the benzotriazole groups can also be controlled by using either 4- or 5-substituted benzotriazole derivatives.

Characteristic Raman peaks can be engineered into these molecules by substituting Raman-active groups at various sites. Any of the C—H groups in the structure shown in FIG. 21 would be suitable points for derivatisation. A panel of dyes can therefore be envisioned, each capable of generating one or more characteristic Raman peaks in a spectrum from a dye mixture, thereby enabling simultaneous multiplex measurements.

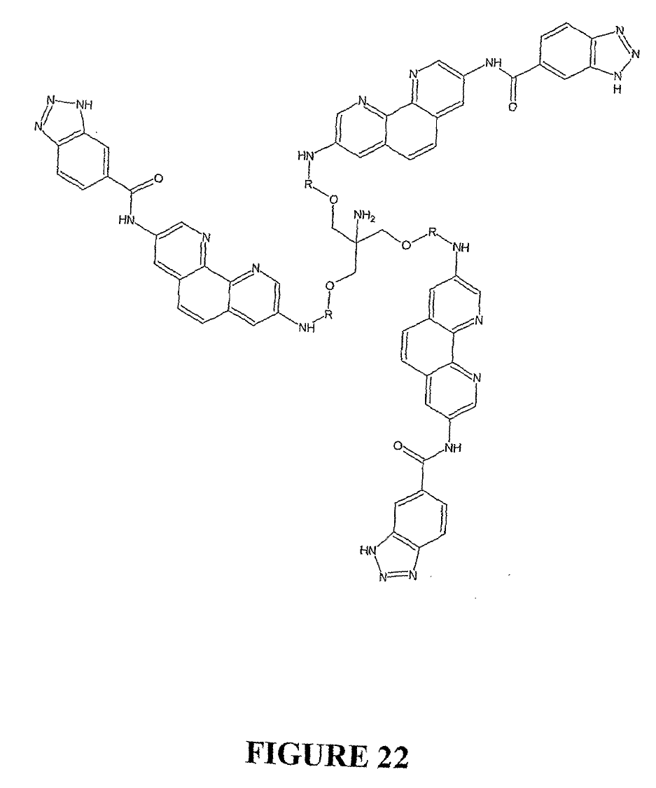

Another example of a tripedal ligand is shown in FIG. 22 in which “R” is a spacer group with 1-4 atom chain length. The three amide groups may be replaced by similar spacer groups (1-4 atom chain length). This ligand could also use diazo groups which would give 3 additional chromophore centres.

Although specific examples have been given, there is a whole family of related metal ion complexes that would be suitable for use as SERRS labels. There is no restriction to Fe²⁺—this is simply one metal ion that is expected to absorb a typical 532 nm laser with good efficiency. The ion used may be any metal that can form a 2⁺ ion and has an octahedral arrangement. Transition metals are often good for this purpose. The ion could be one of vanadium, chromium, copper, magnesium or iron ion. Other transition metals such as cobalt or nickel may well form similar complexes for use with different excitation lasers. Indeed, there is no requirement that the ion be a metal and it could be, for example, an organic molecule provided it fulfilled the requirements detailed above.

Likewise, there is no restriction to octahedral complexes with three bidentate ligands. Tetrahedral and square planar complexes with monodentate and other ligands should also work according to the concepts of this invention. The key concept is that the ligands should be chosen or engineered to have an electronic structure able to transfer energy from the excited state to a non-radiative decay process leading to reduced fluorescence and enhanced Raman scatter. The MLCT mechanism is one way to achieve this, but it should be appreciated that there may be alternative mechanisms that achieve the same goal.

An embodiment of the invention may comprise an analyte carrier to support a dye as described above, along with molecules to be analysed, within an analyte region; and a detector which provides laser radiation to the analyte region on the carrier and has sensors to detect radiation received from the analyte region. The response of the dye is the scattered radiation resulting from incident laser radiation and is detected by these sensors. Together the analyte carrier and detector comprise a detector assembly.

The analyte carrier may contain a metal surface for performing SERS and SERRS as explained above. The detector itself can comprise various forms of laser source and sensors. The embodiments of analyte carrier, appropriate to the detector can take various forms. The preferred embodiment is a microfluidic chip, but other embodiments include a suitably modified microtiter plate as described later. The analyte carrier is thus a so-called “lab on chip”.

1. A method of detecting the presence, absence or quantity of a dye in a sample in a reaction region, comprising:
providing a dye comprising a ligand ion complex, the ligand having a lowest unoccupied electron level and the ion having an excited electron level, the lowest unoccupied electron level of the ligand having an energy level such that an electron in the excited electron level of the ion may transfer non radiatively to the lowest unoccupied electron level of the ligand, the complex having a ground state electron level;
illuminating the dye with a specified wavelength of radiation to detect the presence, absence or quantity of dye;
detecting radiation from the illuminated dye;
wherein the electron levels of the complex and the wavelength of the radiation are arranged such that electrons in the ground state are promoted to an excited state by photon absorption and it is energetically favourable for electrons to transfer to the lowest unoccupied electron level of the ligand from the excited electron level of the ion and undergo non-radiative relaxation via a thermally accessible electron level between the ground state electron level of the complex and the excited electron level of the ion to the ground state electron level.

2. A method of detecting the presence, absence or quantity of a dye according to claim 1 wherein the energies of the lowest unoccupied electron level of the ligand and the excited electron level of the ion are within k_{b}T of each other.

3. A method of detecting the presence, absence or quantity of a dye according to claim 2 wherein the difference in energy between the lowest unoccupied electron level of the ligand and the thermally accessible electron level and between the thermally accessible electron level and the ground state electron level are both k_{b}T or less.

4. A method of detecting the presence, absence or quantity of a dye according to claim 1, wherein the illuminating radiation is of an energy sufficient to excite electrons from the ground state of the ion to the excited electron level of the ion.

5. A method of detecting the presence, absence or quantity of a dye according to claim 4 wherein the wavelength of the illuminating radiation is such that the energy provided is within k_{b}T of the energy difference between the excited energy level of the ion and the ground state of the ion.

6. A method of detecting the presence, absence or quantity of a dye according to claim 1 wherein an excited electron which transfers to the lowest unoccupied electron level of the ligand can relax via the thermally accessible electron level to the ground state of the complex without the need for a spin transition.

7. A method of detecting the presence, absence or quantity of a dye according to claim 1 wherein the existence of the thermally accessible electron energy level provides an alternative relaxation pathway for an electron in an excited state and reduces the probability of a photon being emitted when the electron in the excited state relaxes.

8. A method of detecting the presence, absence or quantity of a dye according to claim 1 wherein the ligand ion complex has thermal vibrational modes available to accept energy resulting from the thermal relaxation of an electron.

9. A method of detecting the presence, absence or quantity of a dye according to claim 8 wherein the ligand ion complex has vibrational modes that are thermally accessible to the energy of an electron transitioning between the lowest unoccupied electron energy level of the ligand and the thermally accessible electron energy level and between the thermally accessible electron energy level and the ground state electron energy level.

10. A method of detecting the presence, absence or quantity of a dye according to claim 1 wherein the ion is any metal that can form a 2⁺ ion and has an octahedral arrangement.

11. A method of detecting the presence, absence or quantity of a dye according to claim 1 wherein the ion is one of a vanadium, chromium, copper, magnesium or iron ion.

12. A dye comprising a binding group:
a ligand ion complex, the ligand having a lowest unoccupied electron level and the ion having an excited electron level, the lowest unoccupied electron level of the ligand having an energy level such that an electron in the excited electron level of the ion may transfer non radiatively to the lowest unoccupied electron level of the ligand, the complex having a ground state electron level;
wherein the electron levels of the complex are arranged such that electrons in the ground state may be promoted to an excited state by photon absorption and it is energetically favourable for electrons to transfer to the lowest unoccupied electron level of the ligand from the excited electron level of the ion and undergo non-radiative relaxation via a thermally accessible electron level between the ground state electron level of the complex and the excited electron level of the ion to the ground state electron level.

13. A dye according to claim 12 wherein the energies of the lowest unoccupied electron level of the ligand and the excited electron level of the ion are within k_{b}T of each other.

14. A dye according to claim 13 wherein the difference in energy between the lowest unoccupied electron level of the ligand and the thermally accessible electron level and between the thermally accessible electron level and the ground state electron level are both k_{b}T or less.

15. A dye according to claim 12 wherein an excited electron which transfers to the lowest unoccupied electron level of the ligand can relax via the thermally accessible electron level to the ground state of the complex without the need for a spin transition.

16. A dye according to claim 12 wherein the existence of the thermally accessible electron energy level provides an alternative relaxation pathway for an electron in an excited state and reduces the probability of a photon being emitted when the electron in the excited state relaxes.

17. A dye according to claim 12 wherein the ligand ion complex has thermal vibrational modes available to accept energy resulting from the thermal relaxation of an electron.

18. A dye according to claim 17 wherein the ligand ion complex has vibrational modes that are thermally accessible to the energy of an electron transitioning between the lowest unoccupied electron energy level of the ligand and the thermally accessible electron energy level and between the thermally accessible electron energy level and the ground state electron energy level.

19. A dye according to claim 12 wherein the ion is any metal that can form a 2⁺ ion and has an octahedral arrangement.

20. A dye according to claim 12 wherein the ion is one of a vanadium, chromium, copper, magnesium or iron ion.

21. An analyte carrier for use in a detector assembly arrangement comprising:
a reaction region containing a metal surface and a quantity of a dye according to claim 12;
whereby the presence, absence or quantity of dye can be determined by illuminating the reaction region with a specified wavelength of radiation and detecting the response from the dye.

22. A detector assembly including an analyte carrier according to claim 21 and further comprising a laser light source arranged to illuminate the region near the metal surface and a detector arranged to detect the presence, absence or quantity of dye by detecting the response from the dye.
